(19) United States
(12) Patent Application Publication
(10) Pub. No.: US 2007/0184314 A1
(43) Pub. Date: Aug. 9, 2007

(54) Fuel cell system

(75) Inventor: Fumio Kagami, Kanagawa-ken (JP)

Correspondence Address: FOLEY AND LARDNER LLP;SUITE 500, 3000 K STREET NW, WASHINGTON, DC, 20007, US

(73) Assignee: NISSAN MOTOR CO., LTD., Kanagawa (JP)

(21) Appl. No.: 10/581,347

(22) PCT Filed: Nov. 8, 2004
(86) PCT No.: PCT/JP04/16908

§ 371 Date: Jun. 2, 2006

(30) Foreign Application Priority Data
Dec. 3, 2003 (JP) 2003-404365

(51) Int. Cl. H01M 8/04; H01M 8/18

(52) U.S. Cl. 429/23; 429/21; 429/22; 429/13

(57) ABSTRACT

A fuel cell system and a method of operating a fuel cell system are disclosed wherein an external electric source (4) is provided to apply current to a fuel cell (1), comprised of a polymer electrolyte membrane-electrode catalyst complex having a polymer electrolyte membrane (21) sandwiched between a fuel electrode (24A) and an oxidant electrode (24B) and separators (26, 28) formed with flow channels (27, 29) to supply fuel and oxidant to the polymer electrolyte membrane-electrode catalyst complex, and operative to change a direction in which current is applied to the fuel cell (1).

### TECHNICAL FIELD

This invention relates to fuel cell systems for reducing water excess states in cathodes.

### BACKGROUND ART

Environmental issues, in particular, air pollution by automobile fumes and global warming caused by carbon dioxide and other greenhouse gases, have recently needed fuel cell systems that enable to realize clean exhaust and high energy efficiency.

In general, a fuel cell is an electrochemical device that converts chemical energy of fuels directly to electric energy, based on the electrochemical reactions between fuels such as hydrogen gas or reformed gas containing rich hydrogen and oxidants such as air in a polymer electrolyte membrane-electrode catalyst complex. In particular, solid Polymer Electrolyte Fuel Cells (solid PEFCs), which use solid polymer membrane as an electrolyte, generating high power density are focused on as electric sources for mobile bodies such as automobile.

Such a solid PEFC includes electrolyte sandwiched between an anode electrode, called fuel electrode, to which a fuel is supplied and a cathode electrode, called oxidant electrode, to which an oxidant is supplied.

In the fuel electrode, a hydrogen molecule decomposes to a proton moving toward the oxidant electrode through the electrolyte and an electron moving toward the oxidant electrode through external circuits resulting in generating electric power. In the oxidant electrode, the reaction between oxygen molecules in the supplied air and protons and electrons supplied from the oxidant electrode generates water molecules. The water molecules are drained out into the solid PEFC.

Such a solid PEFC has the following issues: (1) excess water generated by electrochemical reactions in the oxidant electrode inhibits the diffusion of oxidant gas in the oxidant electrode; (2) the excess water is frozen under circumstances with temperatures below 0 degrees Celsius. These issues cause the malfunction of a fuel cell system with a solid PEFC.

To address the issues described above, Japanese Patent Application Laid-Open No. 2003-272686 shows a technique that flow the excess water generated in an oxidant electrode to an electrolyte by supplying a fuel to the oxidant electrode as well as applying current to the electrolyte in a direction from a fuel electrode to the oxidant electrode by using an external electric source. This technique enable to reduce the generation of excess water in the oxidant electrode and prevent freezing of the excess water under circumstances with temperatures below 0 degrees Celsius.

### DISCLOSURE OF THE INVENTION

However, in a fuel cell system adopting this technique, a fuel is directly supplied to an oxidant electrode through fuel supply lines when the fuel cell system reduces excess water generated in the oxidant electrode. Therefore, this technique has an issue that a fuel may be supplied in the oxidant electrode during the fuel cell system normally works if some accidents occur in valves provided to the fuel supply lines. This causes the decrease of electric power generation efficiency and fuel cell durability because of the reaction between a fuel and an oxidant in an oxidant electrode.

To address such issues, the purpose of the present invention is to provide a fuel cell system that enable to inhibit the decrease of electric power generation efficiency and fuel cell durability by preventing the mixing of a fuel and an oxidant in an oxidant electrode during a fuel cell system normally works.

According to the main aspect of the present invention, there is provided a fuel cell system comprising: a fuel cell that includes a polymer electrolyte membrane-electrode catalyst complex composed of a polymer electrolyte membrane sandwiched between a fuel electrode and an oxidant electrode, and a separator formed with channels through which a fuel and an oxidant are supplied to the polymer electrolyte membrane-electrode catalyst complex; an external electric source operative to apply current to the fuel cell and to change a direction in which the current is applied to the fuel cell.

### BRIEF DESCRIPTION OF DRAWINGS

FIG. 1 is a block diagram illustrating the structure of a fuel cell system according to the first embodiment of the present invention.

FIG. 2 is a cross-section view illustrating the structure of a solid polymer electrolyte fuel cell according to the first embodiment of the present invention.

FIG. 3 is a schematic diagram showing how water molecules move in a fuel cell when current is applied to a fuel cell according to the first embodiment of the present invention.

FIG. 4 is a flowchart showing the control procedures for a fuel cell according to the first embodiment of the present invention.

FIGS. 5A and 5B are schematic diagrams showing how water molecules move in a fuel cell when current is applied to a fuel cell according to the first embodiment of the present invention: FIG. 5A shows a situation when an oxidant is supplied to an oxidant electrode; FIG. 5B a situation when a fuel cell system reduces excess water generated in an oxidant electrode.

FIGS. 6A-6D are graphs showing how the controlled variables of a fuel cell change in the time region before and after a direction of current flow is reversed according the first embodiment of the present invention: FIG. 6A shows the amount of a fuel in an oxidant electrode;.FIG. 6B the amount of the water moving toward a fuel electrode; FIG. 6C the amount of the water moving toward an oxidant electrode; and FIG. 6D the amount of water in an oxidant electrode.

FIG. 7 is a graph showing a relationship between the amount of current and the time applying current to a fuel cell according to the second embodiment of the present invention. FIG. 8 is a flowchart showing control procedures for a fuel cell according to the second embodiment of the present invention.

### BEST MODE FOR CARRYING OUT THE INVENTION

Hereinafter, let us provide detailed explanations of the best mode of the present invention with reference to figures.

### First Embodiment

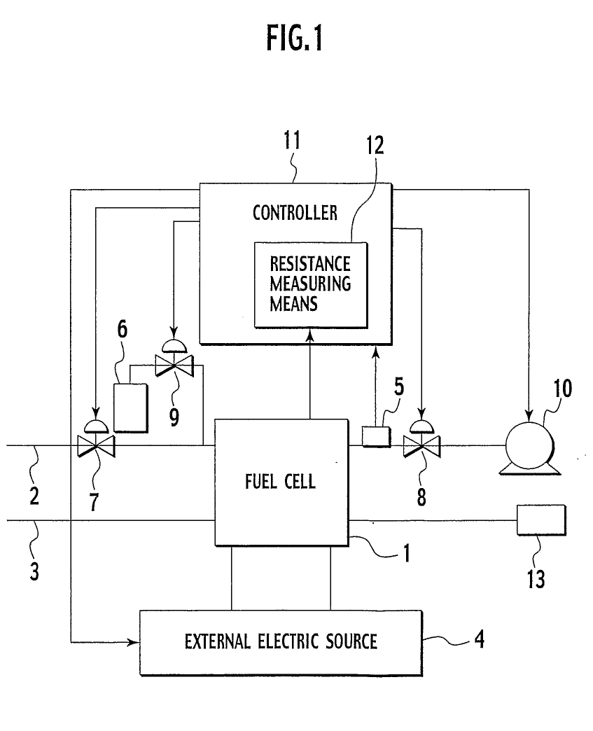

FIG. 1 is a block diagram illustrating the structure of a fuel cell system according to the first embodiment of the present invention. The fuel cell system is comprised of a fuel cell 1 supplied with fuel gas and oxidant gas for generating electric power, an oxidant supply/exhaust line 2 through which an oxidant is supplied to the fuel cell 1 and unreacted oxidant in the fuel cell 1 is exhausted, a fuel supply/exhaust line 3 through which a fuel is supplied to the fuel cell 1 and unreacted fuel in the fuel cell 1 is exhausted, an external electric source 4, a fuel-amount detection means 5, a fuel storage tank 6, valves 7, 8, 9, a compressor and a controller 11.

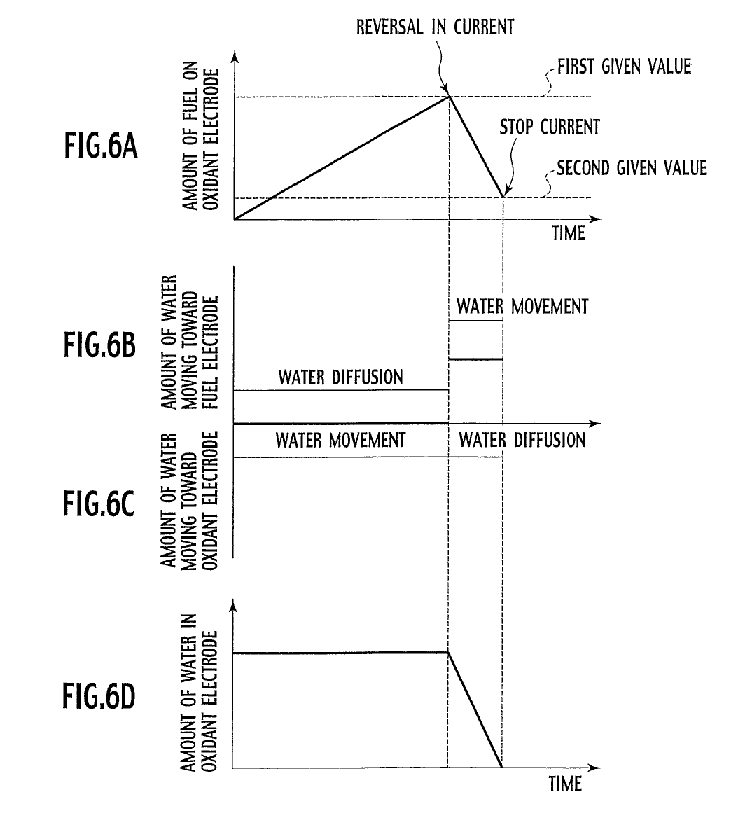

The external electric source 4 is a power supply, which is disconnected from the fuel cell 1 during normal operation and operative to apply current to the fuel cell 1 during performance recovery operations thereof, that is, when removing excess water from an oxidant electrode, and comprised of a power source 41 and switches 42 as shown in FIGS. 5A, 5B.

As shown in FIGS. 5A and 5B, the controller 11 controls the switches 42 to allows a direction in which current is applied to the fuel cell 1 is changed. That is, as shown in FIG. 5A, the controller 11 controls the switches 42 to allows a positive electrode (+electrode) of the power source 41 to be connected to a fuel electrode of the fuel cell 1 and a negative electrode (−electrode) of the power source 41 to be connected to the oxidant electrode of the fuel cell 1 such that current flows from the fuel electrode to the oxidant electrode. On the contrary, as shown in FIG. 5B, the controller 11 controls the switches 42 to allows the positive electrode (+electrode) of the power source 41 to be connected to the oxidant electrode of the fuel cell 1 and the negative electrode (−electrode) of the power source 41 to be connected to the fuel electrode of the fuel cell 1 such that current flows from the oxidant electrode to the fuel electrode.

Further, the controller 11 controls the external electric source 41 such that a value of current to be supplied to the fuel cell 1 can also be varied depending on information detected by the fuel-amount detection means 5.

Furthermore, the fuel-amount detection means 5 is disposed in the oxidant supply/exhaust line 2 at an outlet (an inlet may be sufficed, though) of the fuel cell 1 to detect the amount of fuel being supplied to the oxidant electrode of the fuel cell 1. The fuel-amount detection means 5 is comprised of a hydrogen sensor that detects the amount of hydrogen, serving as fuel gas, or a pressure sensor that detects the amount of hydrogen being supplied to the oxidant electrode of the fuel cell 1 by detecting a pressure of hydrogen.

The fuel storage tank 6 is connected to the oxidant supply/exhaust line 2 at a point close proximity to an inlet of the fuel cell 1 and stores fuel to be supplied to the oxidant electrode of the fuel cell 1 via the valve 9 that is controllably opened during the performance recovery operations of the fuel cell 1.

The valve 7 is connected to the oxidant supply/exhaust line 2 at an oxidant supply line; the valve 8 is connected to the oxidant supply/exhaust line 2 at an oxidant exhaust line; and the valves 7, 8 are opened during normal operation of the fuel cell 1 and closed during the performance recovery operations of the fuel cell 1.

The controller 11 serves as a control center that controls whole operations of the fuel cell system and is realized by a micro computer, including a CPU, a memory and input and output interfaces, required for a computer that controls a variety of operational steps depending on programs. The controller 11 serves to read signals from the fuel cell 1 in the fuel cell system and various sensors, including the fuel-amount detection means 5 and, depending on control logics (soft wares) that are internally and preliminarily stored, delivers commands to various component elements of the fuel cell system, involving the external electric source 4 and the valves 7, 8, 9, to control overall operations required for operation/stop, involving typical performance recovery operations of the fuel cell system, in a manner as described below.

Further, the controller 11 includes a resistance measuring means 12. The resistance measuring means 12 includes a means for measuring resistance of the fuel cell 1 depending on voltage and current of the fuel cell 1 and serves as a water-amount detection means, which detects an amount of water in the oxidant electrode of the fuel cell 1, by measuring resistance of the fuel cell 1. An alternative may be such that the controller 11 includes a means for measuring voltage of the fuel cell 1 to allow the voltage measuring means to serves as a water-amount detection means for detecting an amount of water in the oxidant electrode of the fuel cell 1.

Also, in the fuel cell system with the structure shown in FIG. 1, a vessel 13 may be connected to an outlet side of the oxidant electrode of the fuel cell 1 for storing fuel that could move from the fuel electrode during the performance recovery operations of the fuel cell 1.

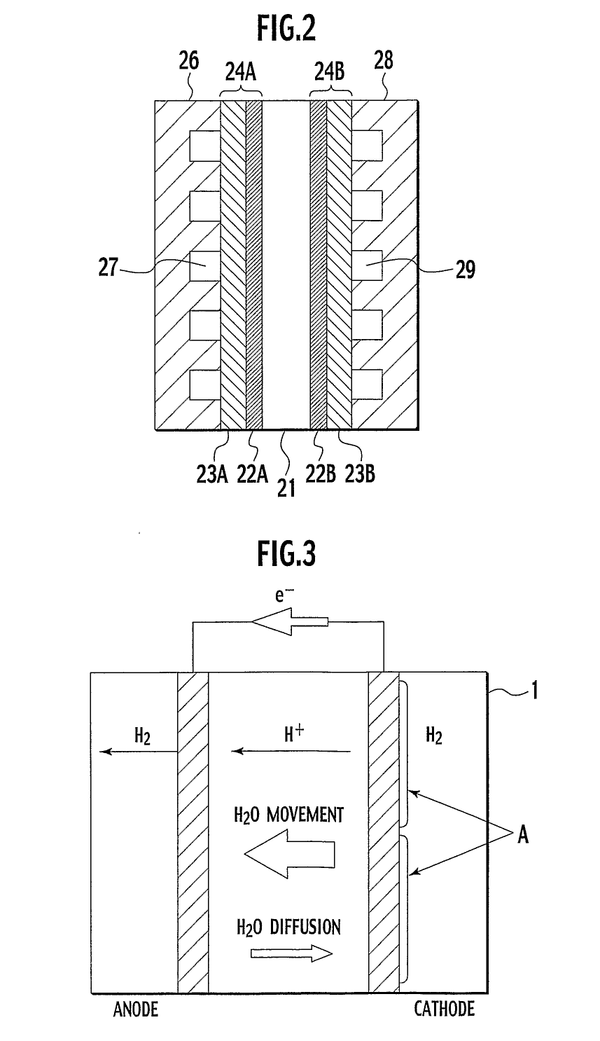

FIG. 2 is a cross-section view illustrating a structure of the solid polymer electrolyte fuel cell 1 shown in FIG. 1. In FIG. 2, one unit of the fuel cell 1 includes an electrolyte membrane 21 formed of a solid polymer membrane, two electrodes (a fuel electrode 24A and an oxidant electrode 24B) disposed on both sides of the electrolyte membrane 21 so as to sandwich the same, and gas flow channels 27, 29 formed on separators 26, 28.

The electrolyte membrane 21 is formed of solid polymer material, such as fluorine-family resin, as a membrane with proton conductivity. The two electrodes 24A, 24b, disposed on both surfaces of this membrane include catalyst layers 22A, 22B and gas diffusion layers 23A, 23B that are made of platinum or platinum and other metals, respectively, and are formed such that surfaces, on which catalysts are present, are kept in contact with the electrolyte membrane 21. The gas flow channels 27, 29 are formed by multiple ribs located on one surface or both surfaces of a dense carbon material, which is gas impermeable, to allow oxidant gas and fuel gas to be supplied from respective gas inlets while exhausting used gases from gas outlets.

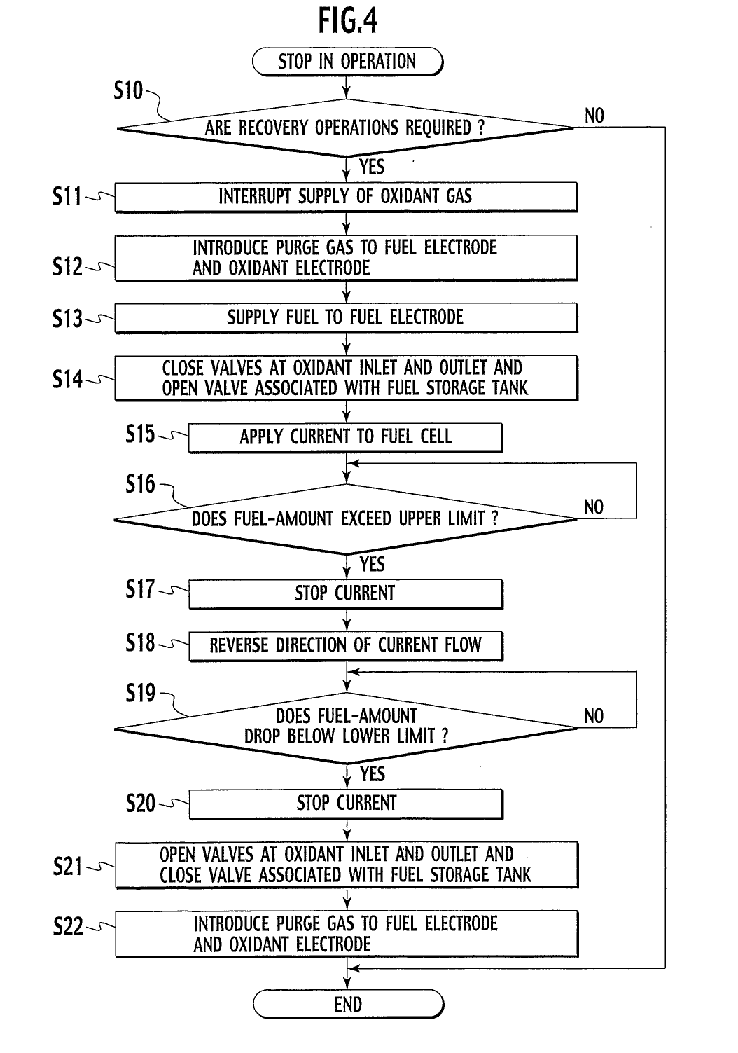

FIG. 3 is a schematic diagram showing how water molecules move in the fuel cell 1 during performance recovery operations thereof. In FIG. 3, when the external electric source 4 is activated to cause current to flow in a direction from the oxidant electrode to the fuel electrode of the fuel cell 1 under circumstances with fuel gas being supplied to the fuel electrode and the oxidant electrode, the following reactions occur on the fuel electrode and the oxidant electrode:
Oxidant Electrode (Cathode Electrode) H_{2→}2H⁺+2e⁻,
Fuel Electrode (Anode Electrode) 2H⁺+2e⁻→H₂.

Then, the water molecules moving from the oxidant electrode to the fuel electrode in the fuel cell 1 increase in a greater volume than those moving from the oxidant electrode to the fuel electrode due to diffusion. Accordingly, excess water can be removed from the oxidant electrode (reacting surface A of the oxidant electrode in FIG. 3) to address the issues of deterioration in performance of the fuel cell.

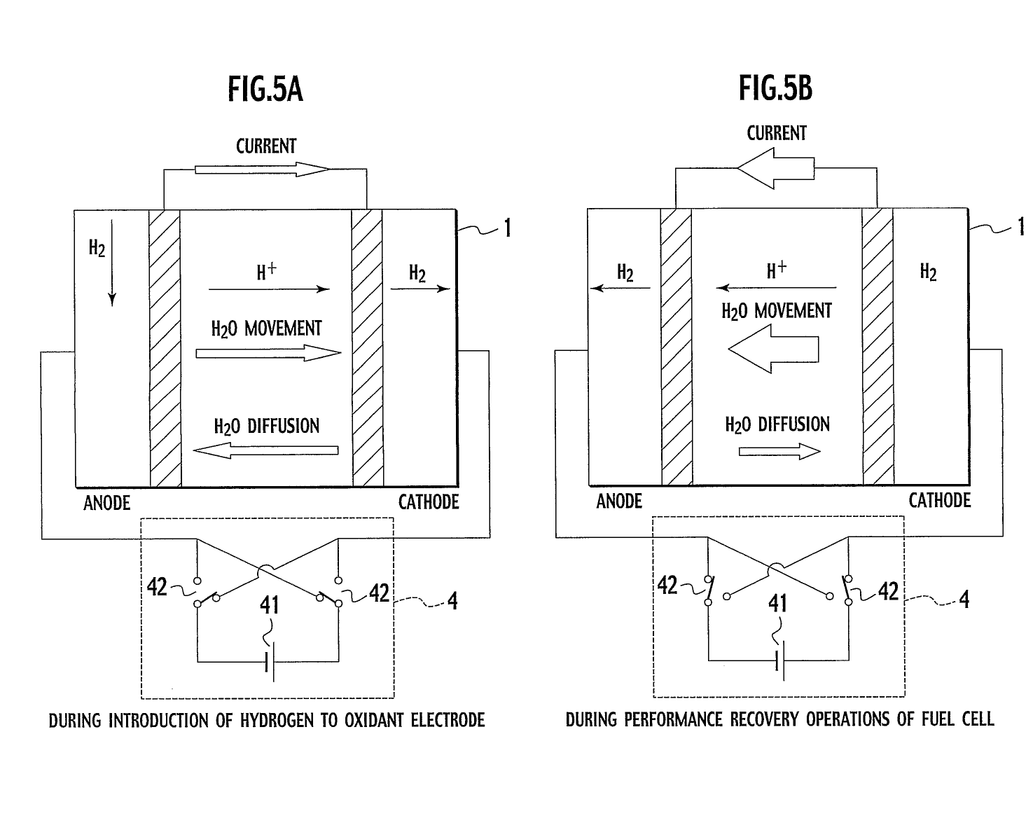

Next, let us explain a basic sequence of performance recovery operations of the fuel cell with reference to a flowchart shown in FIG. 4.

First, after the fuel cell system is stopped in operation, judgment is made to find whether to perform the recovery operations of the fuel cell 1 depending on voltage or a reference value on resistance of the fuel cell 1 that provides a predetermined index on degraded performance of the fuel cell 1 (step S10). That is, in the presence of excess water on the reacting surface of the oxidant electrode of the fuel cell 1, a voltage value or a resistance value of the fuel cell 1 decrease and, hence, if these values are found to exceed the reference value, the operation is terminated without executing the performance recovery operations whereas if the above values drop below the reference value, the operation is shifted to the performance recovery operations.

Then, if the recovery operations are needed, the supply of oxidant to the oxidant electrode is interrupted (step S11). Consecutively, a purge gas is introduced to the oxidant supply/exhaust line 2 and the fuel supply/exhaust line 3 (step S12), causing excess water to be purged from the oxidant supply/exhaust line 2 and the fuel supply/exhaust line 3. Here, although no system for introducing the purge gas is shown in the figures, inactive gas, which is separately prepared, or dried oxidant gas may be supplied. In succeeding step, the fuel is introduced into the fuel electrode (step S13).

Next, the operation is executed to close the valves 7,8 disposed in the inlet and outlet of the oxidant electrode, respectively, while the valve 9, remaining in the closed state, is opened to allow fuel to be introduced to the proximity of the reacting surface of the oxidant electrode from the fuel storage tank 6 (step S14). In consecutive operation, as shown in FIG. 5A, the external electric source 4 is connected to the fuel cell 1 to apply current to the fuel cell 1 to allow current to flow from the fuel electrode to the oxidant electrode (step S15). A current value in this regard is determined such that as shown in FIG. 5A, the movement of water molecules, called Drag, accompanied by fuel moving toward the oxidant electrode via the polymer electrolyte membrane-electrode catalyst complex, occurs at the same rate as the diffusion of water molecules, called Back Diffusion, resulting from a difference in the amount of water (the concentration of water molecules) between the fuel electrode and the oxidant electrode.

Then, upon usage of the fuel-amount detection means 5 to measure the amount of fuel on the oxidant electrode, discrimination is made to find whether the amount of fuel exceeds a first given value (step S16). In discrimination result, if the amount of fuel is less than the first given value, the operation is continued to apply current to the fuel cell 1 until the amount of fuel reaches the first given value.

Here, the first given value is set to a minimal value needed for introducing the water molecules, remaining in the oxidant electrode, to the polymer electrolyte membrane-electrode catalyst complex. With the first embodiment, as set forth above, the amount of water is detected based on the resistance value of the fuel cell 1 measured by the resistance measuring means 12, serving as the means for detecting the amount of water in the oxidant electrode, and by using the resulting amount of water, the amount of fuel (associated with the first given value) to be moved is determined. Also, the higher the amount of water in the oxidant electrode, the greater will be the amount of fuel to be needed. Consequently, by employing the structure to detect the amount of water in the oxidant electrode, recovery work can be achieved with a minimal amount of fuel without using excessive fuel and electric power.

On the contrary, in discrimination result in step S16, if the amount of fuel on the oxidant electrode exceeds the first given value, the external electric source 4 is stopped once to interrupt the application of current to the fuel cell 1(step S17) and, thereafter, as shown in FIG. 5B, the external electric source 4 is switched over in another mode to apply current to the fuel cell 1 in a reversed direction opposite to a direction in which current flows in a preceding stage (step S18).

When this takes place, the fuel being supplied to the fuel electrode may be interrupted, thereby enabling conservation of the amount of fuel. A value of current, to be applied to the fuel cell 1 in the reversed direction, is set to a greater value than that of current applied to the fuel cell 1 in the preceding stage such that as shown in FIG. 5B, a rate of the movement of water molecules, accompanied by the movement of fuel to the fuel electrode via the polymer electrolyte membrane-electrode catalyst complex, exceeds a rate of the diffusion of water molecules caused by a difference in the concentration of water molecules between the fuel electrode and the oxidant electrode.

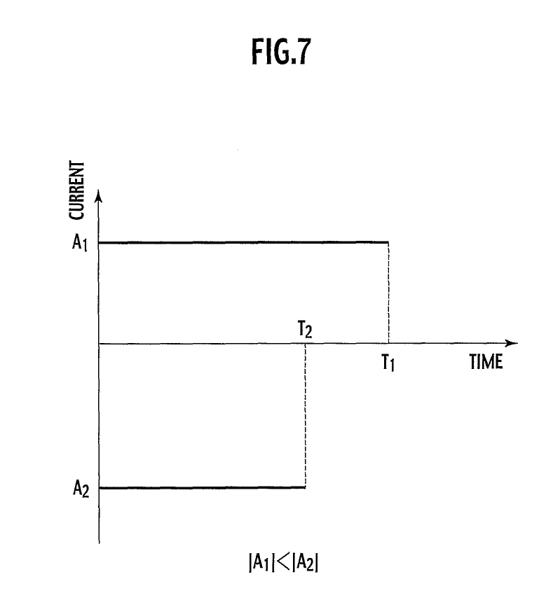

Next, discrimination is made to find whether the amount of fuel being supplied to the oxidant electrode drops below a second given value (step S19). In discrimination result, if the amount of fuel does not drop below the second given value, the operation is continued to apply current to the fuel cell 1 until the amount of fuel drops below the second given value. Here, the second given value is set to a minimal value so as not to cause damages to the fuel cell 1 even during application of current thereto. On the contrary, in discrimination result in step S19, if the amount of fuel drops below the second given value, the external electric source 4 is stopped to interrupt the application of current to the fuel cell 1 (step S20). During a series of operations described above, the amount of fuel in an oxidant electrode, the amount of water moving toward the fuel electrode, the amount of water moving toward the oxidant electrode and the amount of water in the oxidant electrode, before and after a current flow direction is reversed, vary as shown in FIGS. 6A to 6D.

Finally, the valve 9 is closed to interrupt the supply of fuel to the fuel cell 1 from the fuel storage tank 6 while the valves 7, 8 are opened (step S21) to introduce a purge gas to the fuel electrode and the oxidant electrode (step S22) and after unreacted fuel is purged from the fuel electrode and the oxidant electrode, the operation is stopped.

As set forth above, with the first embodiment, the fuel cell 1 is provided with the external electric source 4 operative to apply current to the fuel cell and having positive and negative electrodes available to be switched over, whereby when fuel is introduced to the fuel electrode while current is caused to flow from the oxidant electrode to the fuel electrode, it is possible for fuel, required for achieving performance recovery of the fuel cell 1 through application of current from the fuel electrode to the oxidant electrode, to move from the fuel electrode to the oxidant electrode via the polymer electrolyte membrane-electrode catalyst complex. Consequently, no need arises for valves, required for directly introducing fuel from the fuel electrode to the oxidant electrode via conduits, to be provided with a resultant capability of avoiding a probability for the mixing between fuel and oxidant on the oxidant electrode due to failures that could occur in the valves during normal operation.

Further, with the external electric source 4 providing a capability of permitting current to flow from the fuel electrode to the oxidant electrode after the current is applied to flow from the oxidant electrode to the fuel electrode, it becomes possible to cause fuel, moved from the fuel electrode to the oxidant electrode, to return to the fuel electrode again. In addition, as shown in FIG. 3, since the water molecules present in the oxidant electrode move to the polymer electrolyte membrane-electrode catalyst complex, the deterioration in performance of the fuel cell, resulting from excess water in the oxidant electrode, can be addressed.

Furthermore, due to a capability of the external electric source 4 for varying the magnitude of current, the use of a decreased current value during movement of fuel from the fuel electrode toward the oxidant electrode enables the movement of water molecules, accompanied by fuel moving from the fuel electrode toward the oxidant electrode, to be adjusted such that it occurs at the same rate as the diffusion of water molecules resulting from a difference in the concentration of water molecules between the fuel electrode and the oxidant electrode. In the meanwhile, the use of an increased current value, when fuel is caused to move from the oxidant electrode to the fuel electrode, allows the movement of water molecules, accompanied by fuel moving from the oxidant electrode toward the fuel electrode, to occur at a greater rate than the diffusion of water molecules resulting from the difference in the amount of water between the fuel electrode and the oxidant electrode whereby the water molecules on the oxidant electrode surface are introduced to the polymer electrolyte membrane-electrode catalyst complex to enable efficient recovery in performance of the fuel cell 1.

Moreover, with the fuel-amount detection means 5 provided, the detected fuel-amount and the predetermined first given value are compared, thereby enabling to prevent an excessive increase in the amount of fuel being supplied to the oxidant electrode. This suppresses the pressure difference between the fuel electrode and the oxidant electrode to a minimal value, thereby suppressing the occurrence of power consumption, control times and damages to the polymer electrolyte membrane-electrode catalyst complex caused by the pressure difference to a minimum level.

Also, since no probability occurs for current to flow through the oxidant electrode with no fuel present thereon, the oxidant electrode can be avoided from corrosions. Additionally, with the fuel-amount detection means 5 comprised of the hydrogen sensor or the pressure sensor mounted on at least one of the inlet and outlet of the oxidant electrode of the fuel cell 1, the amount of fuel can be more precisely detected from the outside of the fuel cell 1.

With the fuel cell system provided with means for detecting the amount of water on the reacting surface of the oxidant electrode, discrimination can be made to find whether there is a need for executing performance recovery operations of the fuel cell 1 in the presence of an excess increase in the amount of water on the reacting surface of the oxidant electrode. In the meanwhile, if judgment is made that there is no need for executing performance recovery operations, the amount of fuel required for performance recovery operations and consumption of electric power can be saved.

Due to a structure wherein the means for detecting the amount of water on the reacting surface of the oxidant electrode is constructed as the means for measuring voltage of the fuel cell 1 or the resistance measuring means 12 for detecting resistance of the fuel cell 1, no need arises for the reacting surface of the oxidant electrode to be directly provided with mean for detecting the amount of water, and the amount of water on the reacting surface of the oxidant electrode can be easily detected from the outside of the fuel cell 1.

With the valves 7, 8 disposed in the oxidant supply/exhaust line 2 on at least one of the upstream and downstream of the fuel cell 1, fuel, generated in the oxidant electrode, can be stored in areas in a vicinity of the reacting surface of the oxidant electrode. This enables fuel to be more efficiently used and, further, electric energy needed for introducing fuel into the oxidant electrode can be saved.

By preliminarily setting the amount of fuel to a minimal value needed for the water molecules, present on the oxidant electrode, to be introduced to the polymer electrolyte membrane-electrode catalyst complex, the fuel consumption can be minimized with resultant saving in electric power.

With the fuel cell system provided with a vessel for storing fuel moved from the fuel electrode, fuel, moved from the fuel electrode, can also be stored in other areas than gas flow channels and conduits associated with the oxidant electrode. This enables the issues of shortage of fuel on the oxidant electrode, which could occur during performance recovery operations of the fuel cell 1, to be addressed. Also, even if fuel, remaining in the vessel for storing fuel during normal operation, leaks to the oxidant supply/exhaust line, the provision of the vessel in the oxidant supply/exhaust line 2 on the downstream side of the fuel cell 1 enables the mixing between fuel and oxidant on the reacting surface of the oxidant electrode to be avoided during operations of the fuel cell 1.

### Second Embodiment

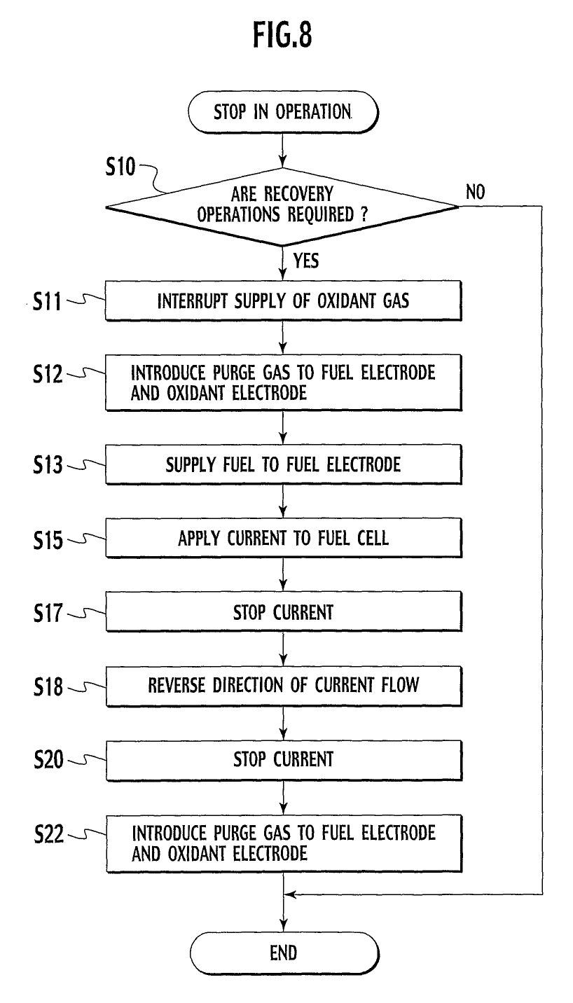

A fuel cell system of a second embodiment features in that in contrast to the fuel cell system of the first embodiment, the fuel-amount detection means 5, shown in FIG. 1, is dispensed with and the fuel cell 1 is applied with current from the external electric source 4 in another mode that, as shown in FIG. 7, is preliminarily set to provide a current value Al and turn-on time T1 for current to flow from an oxidant electrode to a fuel electrode and a current value A2 and turn-on time T2 for current to flow from the fuel electrode to the oxidant electrode. Also, the turn-on time, in which current is applied to the fuel cell 1, is calculated based on the amount of fuel needed for recovering performance of the fuel cell.

A basic sequence of performance recovery operations to be executed in the fuel cell in the second embodiment takes a sequence, shown in FIG. 8, in which judgment in steps S16 to step S19 is omitted from the sequence of the first embodiment shown in FIG. 4 whereas the other steps are similar to those of the sequence shown in FIG. 4. Also, in FIG. 8, the operations in step S14 and step S21 are omitted.

With such features being adopted, the second embodiment is enabled to have an advantage, in addition to the effects obtained in the first embodiment, with no need for providing hard ware as the fuel-amount detection means 5, resulting in a capability of miniaturization and simplification in structure.

### INDUSTRIAL APPLICABILITY

As set forth above, with the present invention, the fuel cell 1 is provided with the external electric source 4 operative to apply current to the fuel cell and having positive and negative electrodes available to be switched over, whereby when fuel is introduced to the fuel electrode while current is caused to flow from the oxidant electrode to the fuel electrode, it is possible for fuel, required for achieving performance recovery of the fuel cell 1 through application of current from the fuel electrode to the oxidant electrode, to move from the fuel electrode to the oxidant electrode via the polymer electrolyte membrane-electrode catalyst complex. Consequently, no need arises for valves, required for directly introducing fuel from the fuel electrode to the oxidant electrode via conduits, to be provided with a resultant capability of avoiding a probability for the mixing between fuel and oxidant on the oxidant electrode due to failures that could occur in the valves during normal operation.

The entire content of Japanese Patent Application No. P2003-404365 with a filing data of Dec. 3, 2003 is herein incorporated by reference.

Although the present invention has been described above by reference to certain embodiments of the invention, the invention is not limited to the embodiments described above and modifications will occur to those skilled in the art, in light of the teachings. The scope of the invention is defined with reference to the following claims.

1. A fuel cell system, comprising:
a fuel cell including a polymer electrolyte membrane-electrode catalyst complex composed of a polymer electrolyte membrane sandwiched between a fuel electrode and an oxidant electrode, and a separator formed with channels through which a fuel and an oxidant are supplied to the polymer electrolyte membrane-electrode catalyst complex; and
an external electric source operative to apply current to the fuel cell and to change a direction in which the current is applied to the fuel cell.

2. The fuel cell system according to claim 1, further comprising:
a controller controlling the external electric source to flow forward current in a direction from the fuel electrode to the oxidant electrode of the fuel cell as well as controlling a first valve to supply a fuel to the oxidant electrode of the fuel cell, thereafter, reversing the direction of the forward current, during a performance of the fuel cell is recovered.

3. The fuel cell system according to claim 2, wherein
the controller controls a value of the reversed current to become greater than that of the forward current.

4. The fuel cell system according to claim 2, further comprising:
fuel-amount detection means detecting an amount of the fuel present on the oxidant electrode of the fuel cell, wherein
the controller controls the external electric source to reverse the direction of the forward current when the amount of the fuel present on the oxidant electrode of the fuel cell exceeds a first given value.

5. The fuel cell system according to claim 4, wherein
the controller controls the external electric source to stop applying the reversed current to the fuel cell when the amount of the fuel present on the oxidant electrode of the fuel cell drops below a second given value less than the first given value.

6. The fuel cell system according to claim 4, wherein
the fuel-amount detection means includes a sensor mounted on at least one of an inlet and outlet of the oxidant electrode of the fuel cell to detect at least one of hydrogen and pressure present in the oxidant electrode.

7. The fuel cell system according to claim 3, further comprising:
water-amount detection means detecting an amount of water on a reacting surface of the oxidant electrode.

8. The fuel cell system according to claim 7, wherein
the water-amount detection means detects an amount of water on the reacting surface of the oxidant electrode depending on at least one of a voltage value and a resistance value of the fuel cell.

9. The fuel cell system according to claim 3, further comprising:
a second valve disposed in at least one of an inlet and outlet of the oxidant electrode of the fuel cell to shut off at least one of the oxidant to be supplied to the oxidant electrode of the fuel cell and the oxidant to be exhausted from the oxidant electrode of the fuel cell.

10. The fuel cell system according to claim 7, wherein
an amount of the fuel to be supplied to the oxidant electrode of the fuel cell is determined depending on the amount of water in the oxidant electrode detected by the water-amount detection means.

11. The fuel cell system according to claim 1, further comprising:
a vessel disposed in an outlet of the oxidant electrode of the fuel cell to store the fuel.

12. A method of operating a fuel cell system comprising a fuel cell that includes a polymer electrolyte membrane-electrode catalyst complex composed of a polymer electrolyte membrane sandwiched between a fuel electrode and an oxidant electrode, and an external electric source operative to apply current to the fuel cell, when a performance of the fuel cell is recovered, comprising:
supplying fuel to the oxidant electrode of the fuel cell;
activating the external electric source to cause current to flow in a direction from the fuel electrode to the oxidant electrode of the fuel cell; and
switching the external electric source to cause the current to flow in a direction from the oxidant electrode to the fuel electrode.
